(19) United States
(12) Patent Application Publication
(10) Pub. No.: US 2008/0015088 A1
(43) Pub. Date: Jan. 17, 2008

(54) Gymnastic machine

(76) Inventor: Alessandro Del Monaco, Rimini (IT)

Correspondence Address: ABELMAN, FRAYNE & SCHWAB, 666 THIRD AVENUE, 10TH FLOOR, NEW YORK, NY, 10017, US

(21) Appl. No.: 11/827,635

(22) Filed: Jul. 11, 2007

(30) Foreign Application Priority Data
Jul. 12, 2006 (IT) RA2006A000041

(51) Int. Cl. A63B 26/00; A63B 24/00; G08B 7/00

(52) U.S. Cl. 482/4; 340/540; 482/23

(57) ABSTRACT

Gymnastic machine (1) includes a frame (10), an exercise station (20) associated with the frame (10), at least a gymnastic implement (30) usable within the exercise station (20) for the execution of a training session, load group (40) supported by the frame (10) and coupled to each gymnastic implement (30), and a signaling device (50) which is provided, so predisposed as to give information on the use status of the implement (30) outside exercise station (20), in such a way as to reduce waiting times between two successive uses.

### BACKGROUND OF THE INVENTION

1. Field of the Invention

The present invention relates to a gymnastic machine. In particular, the present invention relates to a gymnastic machine provided with a signaling device. In more detail, the present invention relates to a gymnastic machine provided with a signaling device effectively usable for giving information on the use status thereof. Furthermore, the present invention relates to a signaling device and to a method for signaling the use status of a gymnastic machine.

2. Description of the Prior Art

In the field of gymnastic machines there are well-known display devices for providing the users with various kinds of information. These display devices may be of different kinds according to the type of gymnastic machine with which they are associated. In the case of gymnastic machines for cardiovascular/aerobic training, such as those of the Applicant's Excite line, the display devices are grouped in a console carried by the machine itself in such a position as to be maintained constantly in front of the face of the training user, in order constantly to update him/her on the real manner in which an exercise is perform instant by instant and hence on the actual progress of the exercise. Therefore, from the observation of the data provided by the instruments it is possible to obtain information on the activity performed and on what still remains to be performed. Also in the case of machines for anaerobic muscular training, such as those of the Applicant's Selection line, one frequently observes the presence of a console carried in such a position that it faces the training user to provide information on the correct way of performing the movement, on the repetitions completed, on the dynamics of the exercise and on the repetitions still to be executed.

It should be noted that positioning and sizing of the consoles, and naturally of the display devices carried by these consoles, are so designed as to be viewable exclusively by the training user or by a trainer in the user's trust, essentially for reasons of confidentiality of the user's personal data, both in terms of setting and of the result of the training session. On the other hand, in this way it is impossible to predict after how long the machine will be freely accessible by another user for those who would like to employ a given machine after the user currently training. The need to have this information available is particularly important especially in the case of users who have reduced time margins to frequent a gym for performing physical activities. It frequently occurs that persons with this problem give up frequenting a gym, or simply discard a priori the possibility of exercising in the nearest gym, simply because there is a high risk of not being able to complete the training sessions within reasonable estimated times. On the other hand, it is considered absolutely inappropriate to propose to the users of a gym to query the other training users to optimize the waiting time on the machines to be used to complete one's training session, since this could annoyingly distract the concentration of these users from the activity they are performing.

In view of the above description, the problem of knowing a user's training time still remaining on a machine is currently unsolved and represents an interesting challenge for the applicant, who has self-imposed the goal of broaden the ranks of those who regularly frequent gyms even to those who have little tolerance for prolonged interruptions of their physical activity in the shift from one machine to the other.

In view of the above description, it would be desirable to have available a gymnastic machine which, in addition to enabling to limit and possibly to overcome the typical drawbacks of the art illustrated above, could define a new standard for these types of machines. Consequently, these innovative gymnastic machines would be particularly indicated to be installed in public gyms or wherever groups of users have to share gymnastic machines. Clearly, the availability of machines of this kind would enable gym operators to maximize the degree of saturation of their fleet of machines, due to the reduction of idle times between two successive uses of each machine.

### SUMMARY OF THE INVENTION

An object of the present invention is to provide a gymnastic machine that allows the disadvantages described above to be solved, and which is suitable to satisfy a plurality of requirements that to date have still not been addressed, and therefore, suitable to represent a new and original source of economic interest and capable of modifying the current market of gymnastic machines but also of gym users, thanks to the possibility of enhancing customer loyalty even among users who have fewer resources of free time to dedicate to physical training.

A further object of the present invention is to provide a control unit for a gymnastic machine that is provided with a signaling device effectively usable to give information on the respective use status.

Another object of the resent invention is to provide a signaling method for signaling the use status of a gymnastic machine.

A still further object of the present invention is to provide a method for signaling the use status of a gymnastic machine.

Yet another object of the present invention is to provide, a method is for signaling the use status of a gymnastic machine.

These and other objects of the present invention which will become apparent hereinafter, are achieved by providing a gymnastic machine, including a frame provided with a base, an exercise station associated with the frame, at least a gymnastic implement usable within said exercise station for the execution of a training session, load means supported by the frame and coupled to each gymnastic implement; and a signaling device so predisposed as to give information on the use status of said implement outside the exercise station, in such a way as to reduce the waiting times between two successive uses of the exercise station.

### BRIEF DESCRIPTION OF THE DRAWINGS

Further characteristics and advantages of the gymnastic machine and of the method for signaling the use status of a gymnastic machine according to the present invention will be more apparent from the description below, set forth with reference to the accompanying drawings, which illustrate at least one non-limiting example of embodiment, in which identical or corresponding parts of the device are identified by the same reference numbers.

In the drawings:

FIG. 1 is a side elevation view of a first preferred embodiment of the present invention with some parts removed for the sake of clarity;

FIG. 2 is a schematic block view, in enlarged scale, of a detail extracted from FIG. 1;

FIG. 3 is a variant of a detail extracted from FIG. 2;

FIG. 4 is a variant of a detail extracted from FIG. 2;

FIG. 5 is a variant of a detail extracted from FIG. 2;

FIG. 6 is a side elevation view of a variant of FIG. 1, with some parts removed for the sake of clarity;

FIG. 7 is a schematic perspective view of a second preferred embodiment of the present invention; and

FIG. 8 is a schematic perspective view of a second preferred embodiment of the present invention;

FIG. 9 is a schematic perspective view in enlarged scale of a second detail extracted from FIG. 7; and

FIG. 10 is a side elevation view of FIG. 7, with some parts removed for the sake of clarity.

### DETAILED DESCRIPTION OF THE PREFERRED EMBODIMENTS

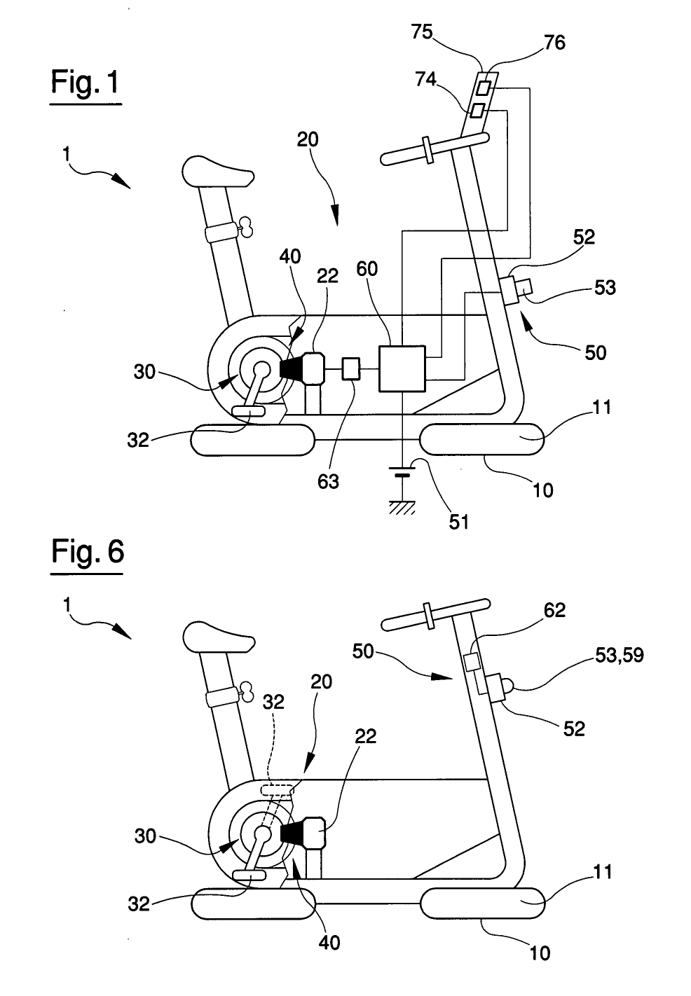

In FIG. 1, number 1 indicates, in its entirety, a gymnastic machine effectively installable in a gym or in any space accessible to the public to make possible the evaluation of the utilization times of the machine 1 to the users who populate the environment outside the machine 1 at any time. It should be stated beforehand that in the following description the type of the machine 1 is irrelevant for the purposes of the description that follows and of the possibility of highlighting the patentability of the present finding, since what is described finds valid application in every type of gymnastic machine for the execution of aerobic or anaerobic physical activity, adequately equipped with the components described below.

Again with reference to FIG. 1, the gymnastic machine 1 comprises a frame 10 provided with at least a base 11, an exercise station 20 associated with the frame 10, at least a gymnastic implement 30 usable within the exercise station 20 for the execution of a training session, a load group 40 supported by the frame 10 and coupled to each gymnastic implement 30. Furthermore, the machine 1 is provided with a signaling device 50 able to provide information on the use status of the implement 30 outside the station 20, and presenting, to this end, at least a display unit 50, each of which is provided with at least a light source 53. It should be specify that, for the sake of practicality, the machine selected to illustrate the present invention is a stationary bike called “Bike Form a” of the Applicant's “Home fitness” line, because of its particular structural simplicity. In this case, each implement 30 is embodied by at least one crank 30 provided with respective pedal 32. Moreover, hereinafter, the terms “use status” identifies any one of the operating conditions of the machine 1, among which being included both the initial part of a training session, and the final part of the training session, which may include the cool-down phase and, naturally, the idle machine condition, intermediate between two successive training sessions.

The signaling device 50 is part of an electronic control unit 60 which comprises, in turn, a calculating device 62 usable to manage the various each implement 30 starting from a given instant in time. This instant normally coincides with the instant in which the training session on the machine 1 started. Alternatively, this given time instant can coincide with the instant when power is applied to the load group, regardless of the source of this power. It should be kept in mind, in fact, that in the case of stationary bikes, of skating simulators and in the case of machines for anaerobic training, the power is produced by the user, but in the case of treadmills the power is supplied by an electric supply network.

Furthermore, it should be specified that it was decided to represent each connection between the components of the control unit 60 with a single branch for the sake of drawing economy, implying that each individual branch can be traveled electronically in the two directions and hence it is indifferently suitable for unidirectional or bi-directional information exchange.

Furthermore, the control unit 60 is interfaced with each implement 30 by means of the interposition of a respective transducer 63 able to detect the current use status of each implement 30. This transducer is connected, at the opposite side from each implement 30, to a logical unit 65, which is, in turn, electronically connected to an information storage device 64 associated to the control unit 60 and connected to the calculating device 62 to exchange information. The logical unit 65 is programmed to assign a given logical value to the current use status of each implement 30; in particular, this given logical value is synthesized in an indicator 80 allocable in an information block which, for the sake of convenience, is denoted by the same reference number 80 and indicates the current use status of the implement 30. Therefore, the control unit 60 is able to update in real time the display unit 52 based on the value of the indicator 80. It may be advisable to specify that in the case of the stationary bike of FIG. 1, the transducer 63 is coupled to an electromagnetic brake 22 of known type of the load group 20 operated directly from the cranks 30.

It should be specified that the information storage device 64 is arranged to contain, in addition to the indicator 80, a plurality of information blocks, among which an information block 66 able to store a data item corresponding to a duration time of the training session, an information block 68 for storing a data item corresponding to a starting time of the use of each implement 30 and an information block 70 able to store a data item corresponding to a residual time duration of use of each implement 30. These information blocks 66, 68, 70 incorporated in the storage device 64 can be updated by means of a keyboard 74 incorporated in a console 75, shown in FIG. 1, or by means of a flash card reader 76 or a reader of information supports of a similar type through the calculating device 62. Both the keyboard 74 and the reader 76 are connected to the control device 60.

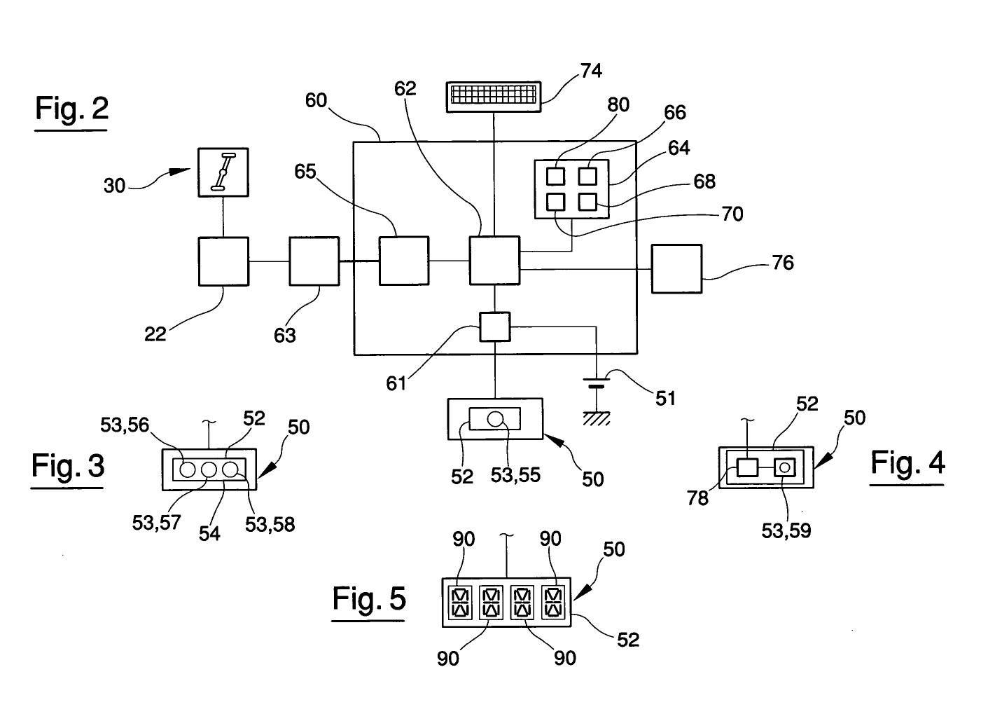

With particular reference to FIG. 2, the light source 53 of the display unit 52 may comprise at least a light-emitting diode 55, more simply called LED, or, with reference to FIG. 3, at least two LEDs or two bulbs having mutually different colors, which may be positioned similarly to a traffic light 54, to give information on the corresponding use status of the implement 30 mutually distinguished outside the station 20. In particular, but without limitation, in FIG. 3 the light sources are three, and they are indicated by the reference numbers 56, 57, and 58.

As it is well known, the LEDs are light sources able to emit a light beam whose color can be determined by values of electrical parameters of current and voltage of the related power supply 51 or it can emit light of a given color, similarly to commonly used incandescent light bulbs or fluorescent lamps.

Therefore, the different chromatism of the light emitted by the led 55 can be obtained simply by varying the parameters of the supply current; in the case of the traffic light 54, instead, the supply current will be selectively sent to one of the light bulbs 56, 57 and 58, also through the calculating device 62. Naturally, the LED 55 and the traffic light 54 are powered by a supply network 51 by means of a switch 61 remotely controlled by the control device 62 and contained inside the control unit 60.

It may be advisable to prescribe that the colors selected for each light source 53, and in particular for the bulbs 56, 57, and 58 respectively are green, red and amber, whilst if the choice were for the LED 55, it would be possible to have a broader range of colors available. In addition, it may be advantageous, in analogy with the convention of road signs, to associate to a use status in which the machine 1 is awaiting a user, and hence inactive, the lighting of the light bulb 56 in such a way as to emit exclusively green light; when the machine 1 is active, to cause the lighting of the light bulb 57 in such a way as to emit exclusively red light; and when the machine 1 is active but in a final stage of the exercise, to cause the lighting of the light bulb 58 in such a way as to emit exclusively amber colored light.

On the other hand, it should be specified that the amber colored light could be obtained using even only two light sources 53, one red and the other one green and arranging for their simultaneous activation, since the amber color can be obtained from mixing these two elementary chromatisms. Naturally, this result is independent of the fact that the two light sources are constituted by LEDs or by light bulbs, but it is linked exclusively by the simultaneity of the switching of the sources. With reference to the duration of the final stage of the exercise, it should be specified that this stage could have variable or standard duration, e.g. from 3 to 5 minutes, based on the prescriptions of a trainer or on the free decisions of a user.

If notifying waiting users the waiting time with approximation is not deemed sufficient, but it is preferred to provide precise indications, the light sources 53 of each unit 52 may comprise at least an eight-segment LED 90, shown only in FIG. 5 and usable for providing the indication of the residual time through a digit that may reflect minutes or seconds left before the end of the exercise. Naturally, the optimal situation may require the use of 2 pairs of eight-segment LEDs 90, in which case the first two LEDs 90 from the left could be used to indicate the minutes remaining before the end of the exercise and the two LEDs 90 on the right to provide indications on the seconds remaining.

Use of the machine 1 and of its respective signaling device 50 is easily understood from the above description and requires no further explanation.

In any case, it may be advisable to specify that the machine 1 is one of the possible embodiments of gymnastic machine through which it is possible to implement a method for signaling the use status of the gymnastic machine. In view of the above description, this method comprises a step of providing information on the use status of the implement 30 outside the station 20; this step is preceded by a step of informing the control unit 60 on the duration of the exercise and is followed by a step of calculating a residual time of use of each implement 30 starting from a given instant in time. This step of calculating the residual time can be achieved through the calculating device 62 and enables to carry out a step of assigning a given value to the indicator 80, signifying the use status of each implement 30; naturally, this step is followed by a step of providing the signaling device 50 with information on the use status of the implement 30 outside the station 20, followed by the step of displaying the given value of the indicator 80 by means of at least the LED 55 or by means of one of the bulbs 56, 57, 58.

Finally, it is clear that modifications and variants can be made to the gymnastic machine 1 described and illustrated herein without however departing from the protective scope of the present invention.

For example, in the simplest embodiment, the calculating device 62 for calculating the residual time can be accomplished very simply through a simple timer, which is indicated in FIG. 6, for the sake of convenience, with the reference number 62, and a fixed light bulb 59 instead of the LED 55 or the traffic light 54. This timer 62 is arranged to provide a pair of electrical impulses, each of which is able to identify a given operating phase and hence alternatively to command the lighting of the fixed light and its respective shutting off, it would be possible to identify, respectively, the start of the terminal part of the exercise and its end. It should be noted that, also according to the present simplified embodiment, the user who chooses to continue his/her training session on the machine 1 whilst this machine 1 is occupied by another user already active aboard it can be informed of the actual use status of the machine 1 and understand whether the user already active on the machine 1 is in the midst of his/her exercise simply by observing the light bulb 59, or whether the user is about to end his/her exercise and hence is getting ready to leave the machine 1. Hence, this awaiting user can decide with full awareness whether to wait for the training user to free the machine 1 or whether to go elsewhere for the continuation of his/her training session.

According to a further embodiment, the sole light bulb 59 can be activated in such a way as to produce intermittent flashes with a different frequency according to the different current use status of the machine 1. In this case, with the bulb 59 an intermitter device 78 can be associated, electronically connected to the calculating device 62 to condition the light bulb 59 to emit light in different manners according to the use status of the implement 30. For example, the light emitted by the light bulb 59 could have intermittence variable with a frequency that is the higher, the closer the end of the exercise, or vice versa. On the other hand, to the continuous emission of light, and hence to the constantly on condition of the light bulb 59, could correspond the indefinite operation of the machine 1; whilst with the machine 1 idle, the light bulb 59 could be maintained conveniently off.

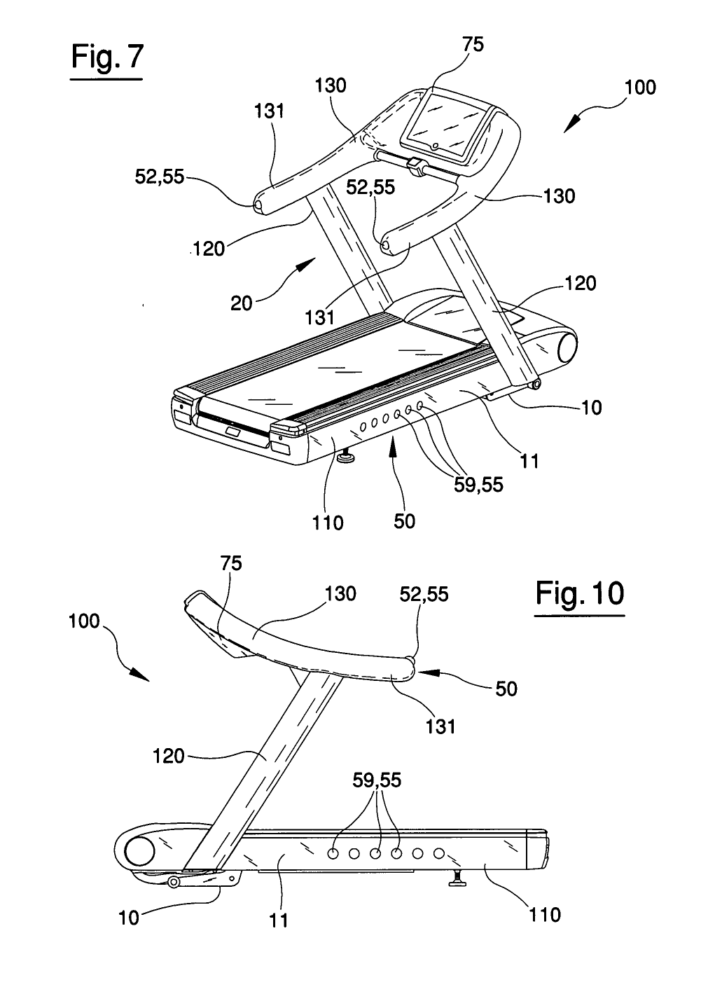

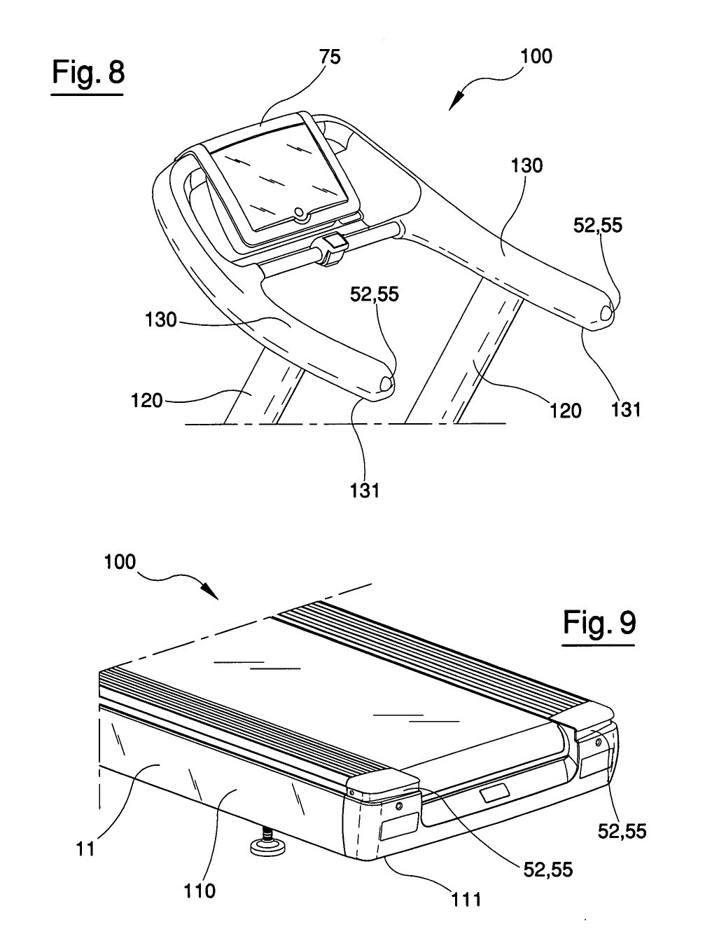

Alternatively to the stationary bike shown in FIGS. 1 and 6, the machine 1 can comprise an endless belt 100 provided with a control unit 60 and with the corresponding signaling device 50 as shown in FIG. 6. This endless belt 100 is provided with a base 11 wherefrom extends upwards a pair of uprights 120, which support a pair of handles 130 that delimit laterally the station 20. Between the handles 130 is positioned a console 75 for the exchange of information with the control unit 60. In this case the display unit 52 could be adapted to present the LED 55 carried in end position and in particular by both the handles 130 in end position 131, as in FIG. 8 or at an edge 111 of the base 11, as in FIG. 7. Alternatively, this LED 55 and/or the traffic light 54 could validly be replaced by a plurality of bulbs 59 carried aligned by at least one flank 110 of the base 11. Each bulb 59 is electrically powered and is connected to the calculating device 62 to command its lighting or shutting off according to the amplitude of the exercise portion that has already been performed and/or remains to be performed. In this latter case, the light bulbs 59, which may be replaced by LEDs 55 to produce lower electrical energy consumption and enable to emit light distinguished by a given chromatism, should all be lighted at the start of the exercise and be shut off, or change color, one by one as time elapses, until they are all off at the end of the training session performed on the treadmill 100.

Naturally, the presence of the LEDs 55 or of the light bulbs 59 can be simultaneous on the treadmill 100 or also alternative, according to the type of set-up selected by the customer or according to other requirements.

In view of the above description, it is easily understood that the device 50 and the control unit 60 of the gymnastic machine 1 described above, in both versions of the stationary bike of FIGS. 1 and 6 and of the treadmill of FIGS. 7-10, enable to provide information on the use status of the machine 1 to those who are outside the machine 1 itself, and hence to divulge the use status of the machine 1 whereon users want to perform an exercise. Therefore, the control unit 60 and the respective signaling device 50 enable to provide sufficient indications to minimize the duration of the interruptions of the physical training activity in the shift from one machine to another to those who are outside the exercise station 20.

It is clear that a gymnastic machine structured like the machine 1 enables gym operators to maximize the degree of saturation of the fleet of machines, to have the opportunity of reducing idle times between two successive uses of each individual gymnastic machine installed.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A gymnastic machine (1) comprising a frame (10) provided with a base (11), an exercise station (20) associated with the frame (10), at least a gymnastic implement (30) usable within said exercise station (20) for the execution of a training session, load means (40) supported by the frame (10) and coupled to each gymnastic implement (30); characterized in that a signaling device (50) is provided, so predisposed as to give information on the use status of said implement (30) outside said exercise station (20), in such a way as to reduce the waiting times between two successive uses of the exercise station (20).

2. A machine according to claim 1, characterized in that said signaling device (50) is associated with a control unit (60) provided with a calculating device (62) for calculating the residual time of the use of each said implement (30) starting from a given instant in time.

3. A machine according to claim 1, characterized in that said signaling device (50) comprises a display unit (52) connected to said calculating device (62) for calculating the residual time.

4. A machine according to claim 3, characterized in that said display unit (52) comprises at least a light source (53) (55) (56, 57, 58) (59) (54).

5. A machine according to claim 4, characterized in that said light source is able to produce light whose chromatism is a function of a given use status of each said implement (30).

6. A machine according to claim 3, characterized in that said display unit (52) comprises two light sources (53) whose color is distinct and mixable to produce an additional distinct color.

7. A machine according to claim 6, characterized in that said light sources (53) of distinct color present, respectively, green and red color.

8. A machine according to claim 3, characterized in that said display unit (52) comprises at least one eight-segment LED (90) employable, in use, to indicate the residual time before the end of a physical training exercise.

9. A machine according to claim 8, characterized in that said display unit (52) comprises two pairs of said eight-segment LEDs (90).

10. A machine according to claim 3, characterized in that said display unit (52) comprises a traffic light (54) provided with a plurality of bulbs (56)(57) (58), each of which being activated in relation to said use status of each said implement (30).

11. A machine according to claim 10, characterized in that said control unit (60) is interfaced with each said implement (30) for detecting their respective current use status and assigning a given value to an indicator (80) of said use status of each said implement (30); said calculating device (62) being connected to said signaling device (50) to update in real time said display unit (52) based on said current value of said indicator (80).

12. A machine according to claim 11, characterized in that said calculating device (62) is provided for calculating said residual time of use of each said implement (30) starting from a time data item corresponding to said given instant in time.

13. A machine according to claim 12, characterized in that said control unit (60) comprises an information storage device (64) conformed to contain at least a first information block (66) able to store a data item pertaining to the duration times of the training session, a second information block (68) able to store a data item pertaining to a starting time of the use of each implement (30) and a third information block (70) able to store a data item corresponding to a residual time duration of the use of each implement (30); the calculating device (62) and the storage device being mutually connected in such a way as to be able to exchange information; electronic connection means being positioned between said storage device (64) to update said display unit (52).

14. A machine according to claim 13, characterized by comprising a reading device (76) for reading an information support coupled to said calculating device (62) and able to interact with said storage device (64) to exchange therewith said first information block (66), said second information block (68), said third information block (70).

15. A machine according to claim 3, characterized in that said display unit (52) comprises a single light (56) able to light up according to a given time scheme to provide information on corresponding mutually distinguished use states of said implement (30) outside said exercise station (20).

16. A machine according to claim 3, characterized by comprising at least an end portion (131) (111 and characterized in that said display unit (52) comprises at least a light source (55) carried in each said end portion (131) (111).

17. A machine according to claim 16, characterized in that each said end portion (111) comprises an edge (111) of said base (11); each said edge (111) being provided with said light source (55).

18. A machine according to claim 17, characterized by comprising at least one handle (130) provided with a respective end portion (131); each said light source (55) being associated with one said end portion (131).

19. A machine according to claim 3, characterized by comprising a base (11) provided with a flank (110) presenting a plurality of light sources (59)(55) substantially aligned to each other; each of said light sources (59) (55) being connected to said calculating device (62) for the respective lighting, shutting off, color change in relation to an amplitude of the portion of exercise that has already been performed and/or is still to be performed.

20. A machine according to claim 4, characterized in that said traffic light (54) comprises a first light source (56), a second light source (57) and a third light source (58); said first, second and third light sources (56, 57, 58) presenting mutually distinct colors and being able to be operated in succession to provide information on corresponding mutually distinct use states of each said implement (30) outside said exercise station (20).

21. A signaling method for signaling the use status of a gymnastic machine including a frame (10), an exercise station (20) associated with the frame (10), at least a gymnastic implement (30) usable within the exercise station (20) and load means (40) supported by said frame (10) and coupled to each said gymnastic implement (30) in said exercise station (20), an electronic control unit (60) able to interface with each implement (30) to detect its current use status; the method being characterized by comprising a step of providing information on the use status of the implement (30) outside said exercise station (20).

22. A method according to claim 21, characterized by comprising a step of informing said control unit (60) of a duration of the exercise followed by a step of calculating a residual time of the use of each implement (30) starting from a given instant in time by means of a calculating device (62) for calculating the residual time and by a step of assigning a given value to an indicator (80) of said use status of each said implement (30) preliminarily to the step of providing information on the use status of each said implement (30) outside said exercise station (20).

23. A method according to claim 21, characterized in that said step of providing information on the status of each said implement (30) outside said exercise station (20) comprises a step of displaying said given value of said indicator (80) by means of at least a light (56)(57)(58).

24. A method according to claim 23, characterized in that the step of displaying said given value of said indicator (80) comprises a step of selectively activating a light (56) (57) (58) of three light bulbs (56, 57, 58) of a traffic light (54) based on the current use status of the implement (30).

25. A method according to claim 24, characterized in that said step of displaying said given value of said indicator (80) comprises a step of electrically activating a light source (59) based on the current value of the indicator (80).

26. A method according to claim 25, characterized in that the step of displaying the given value of the indicator (80) comprises a step of electrically activating a monochromatic light source (59) at a given frequency based on the current value of said indicator (80).

27. A control unit (60) for controlling a gymnastic machine (1) including a frame (10), an exercise station (20) associated with the frame (10), at least a gymnastic implement (30) usable within the exercise station (20) and load means (40) supported by said frame (10) and coupled to each said gymnastic implement (30) in said exercise station (20), an electronic control unit (60) able to interface with each implement (30) to detect its current use status; the control unit being characterized by being so shaped as to provide information on the use status of each corresponding implement (30) outside a station (20) of said gymnastic machine (1).

28. A unit according to claim 27, characterized by comprising a calculating device (62) usable for calculating a residual time of use of each implement (30) starting from a given instant in time.

29. A unit according to claim 27, characterized by comprising a signaling device (50) provided with a display unit (52) connected to said calculating device (62).

30. A unit according to claim 29, characterized in that said calculating device (62) is interfaced with each implement (30) for detecting their respective current use status and assigning a given value to an indicator (80) for indicating the use status of the implement (30); said calculating device (62) being further connected to said signaling device (50) to update in real time said display unit (52) based on the current value of said indicator (80).

31. A unit according to claim 30, characterized in that said display unit (52) comprises a traffic light (54) provided with a plurality of bulbs (56) (57)(58), each of which can be operated in relation to the use status of the implement (30).

32. A unit according to claim 29, characterized in that the display unit (52) comprises a single light (5) able to light up according to a given time scheme to provide information on corresponding mutually distinct use states of the implement (30) outside said exercise station (20).

33. A unit according to claim 30, characterized in that said traffic light (54) comprises a first light (56), a second light (57) and a third light (58) of mutually distinct colors, able to be operated in succession to provide information on corresponding mutually distinct use states of the implement (30) outside said exercise station (20).

34. A unit according to claim 27, characterized by comprising an information storage device (64) so shaped as to contain at least a first information block (66) able to store a data item pertaining to the duration times of the training session, a second information block (68) able to store a data item pertaining to a starting time of the use of each implement (30) and a third information block (70) able to store a data item pertaining to a residual time duration of the use of each implement (30); said calculating device (62) and said storage device being mutually connected in such a way as to be able to exchange information; electronic connection means being positioned between the storage device (64) to update said display unit (52).

35. A unit according to claim 34, characterized in that said control unit (60) comprises a reading device (76) for reading an information support so shaped as to allocate at least a first information block (66) pertaining to the mode of execution of the training session, a second information block (68) pertaining to the duration times of the training session, a third information block (70) of a starting time of the use of each implement (30) and a fourth information block of a residual time duration of the use of each implement (30); said reading device (76) being electronically connected to said storage device (64) to exchange information.
